(19) United States
(12) Patent Application Publication
(10) Pub. No.: US 2014/0123877 A1
(43) Pub. Date: May 8, 2014

(54) VOC FREE PRODUCT

(71) Applicants: Stefan Erkselius, Staffanstorp (SE); Jenny Hua, Arlöv (SE); Johan Fagefors, Malmö (SE); Nils Erik Persson, Södra Sandby (SE); Nicola Rehnberg, Perstorp (SE)

(72) Inventors: Stefan Erkselius, Staffanstorp (SE); Jenny Hua, Arlöv (SE); Johan Fagefors, Malmö (SE); Nils Erik Persson, Södra Sandby (SE); Nicola Rehnberg, Perstorp (SE)

(73) Assignee: BWE I MALMÖ AB, Malmö (SE)

(21) Appl. No.: 14/111,923

(22) PCT Filed: Apr. 5, 2012
(86) PCT No.: PCT/SE2012/050374

§ 371 Date: Nov. 18, 2013

(30) Foreign Application Priority Data
Apr. 18, 2011 (SE) 1150338-0

(51) Int. Cl. C09D 7/12

(52) U.S. Cl. CPC C09D 7/12
USPC 106/287.35; 106/316

(57) ABSTRACT

A VOC free cross linking product for waterborn coatings is described. The crosslinking product comprises at least one cross linking agent and at least one viscosity reducing compound.

### FIELD OF THE INVENTION

The present invention relates to a VOC free crosslinking product for waterborn coatings, to coating formulations comprising such a crosslinking product, to surfaces coated with crosslinking products according to the invention and also to a method for producing a VOC free crosslinking product according to the invention.

### BACKGROUND OF THE INVENTION

Floors derived from natural or manufactured materials such as wood, bamboo, cork, PVC, and/or ceramics are often provided with a coating as protection against wear to maintain an attractive appearance. The coating can be of great variety, e.g. an oil, an alkyd, a urethane modified oil, an industrially applied or on-site applied UV curing acrylate coating, an aqueous acrylic dispersion, an aqueous polyurethane dispersion or hybrids or mixtures thereof.

A coating can form a protective film by physical drying. Such a coating will not be very resistant and is only suitable when requirements for abrasive resistance, scratch resistance, chemical resistance, and hardness are low. For surfaces exposed to heavy wear, a cross linking coating is a necessity. On cross linking, the molecular weight of the coating molecules is increased and the physical and chemical properties are much improved.

A method, popular due to its versatility and simplicity, is to induce cross linking by adding a cross linking agent such as a polyisocyanate, a polyaziridine, a polysilane or mixtures thereof. The viscosity of these additives as such, is frequently higher than acceptable in coatings. In such cases a solvent is added as viscosity reducer to give a product of adequate viscosity, and in case of aqueous coatings, easy dispersability, as disclosed in U.S. Pat. No. 4,663,377 (e.g. acetone) and EP0697424 (e.g. butyrolactone).

Acetone is a very flammable compound and butyrolactone is known to induce nausea, dizziness, visual disturbances, etc. Frequently, N-methyl-pyrrolidone (NMP) is used but resent research reports suggest that it has malign physiological effects. A further disadvantage of this technique is that the addition of a solvent creates volatile organic compound (VOC) which potentially is of environmental and health concern.

### SUMMARY OF THE INVENTION

In view of the unpleasant characteristics of the solvents used together with conventional cross linking agents, it is an object of the present invention to provide crosslinking products not exhibiting hazardous effects, but displaying versatiliy and simplicity in use and also excellent coating properties.

### DETAILED DESCRIPTION OF PREFERRED EMBODIMENTS OF THE INVENTION

In one embodiment of the present invention a VOC free cross linking product for waterborn coatings, comprising at least one cross linking agent and at least one viscosity reducing compound, is provided.

According to one embodiment said at least one cross linking agent and said at least one viscosity reducing compound are present in the VOC free cross linking product in a ratio of 1/10 to 100/1.

In one embodiment said at least one cross linking agent and said at least one viscosity reducing compound are present in the cross linking product in a ratio of 1/5 to 20/1 and in still a further embodiment said at least one cross linking agent and said at least one viscosity reducing compound are present in the cross linking product in a ratio of 1/2 to 10/1.

In still another embodiment said at least one cross linking agent and said at least one viscosity reducing compound are present in the cross linking product in a ratio of 1/1 to 5/1.

In a preferred embodiment of the present invention the boiling point of said at least one viscosity reducing compound is >250° C. at atmospheric pressure.

In one embodiment of the present invention said at least one viscosity reducing compound has a calculated log P of <7.0, preferably <3.5, more preferably <3.1.

According to one embodiment said at least one viscosity reducing compound is chosen from ketones, esters, ethers or mixtures thereof.

In a further embodiment said at least one viscosity reducing compound is chosen from lactates, citrates, tartrates, malates, phosphates, silicates, and glycerol esters or mixtures thereof.

In a preferred embodiment said at least one viscosity reducing compound is a citrate.

In one embodiment the citrate is chosen from triethyl citrate, tributyl citrate, triethyl acetylcitrate or a mixture thereof.

In a further preferred embodiment said at least one viscosity reducing compound is a glycerol ester.

In one embodiment the glycerol ester is chosen from triacetin, tripropionin, tributyrin or a mixture thereof.

According to one aspect the present invention provides a coating formulation comprising a VOC free cross linking product according to the present invention.

In a preferred embodiment the coating formulation further comprises at least one finish.

In one embodiment of the coating formulation the cross linking product and said at least one finish are present in a ratio of 1/100 to 1/1.

In a further embodiment the cross linking product and said at least one finish are present in a ratio of 1/50 to 1/2.

In still another embodiment the cross linking product and said at least one finish are present in a ratio of 1/25 to 1/3.

In a further embodiment the cross linking product and said at least one finish are present in a ratio of 1/10 to 1/5.

According to one aspect the present invention provides a surface coated by a formulation according to the present invention.

In still a further aspect the present invention provides a method for producing a VOC free crosslinking product according to the present invention, wherein a cross linking agent is mixed with a viscosity reducing agent.

### DEFINITIONS

log P: calculated distribution factor between 1-octanol and water.

VOC: refers to organic chemical compounds which have significant vapor pressures and which can affect the environment and human health. VOCs are typically not acutely toxic but have chronic effects.

Finish: a fully formulated ready to use product for the protection of surfaces. May or may not be complemented by a cross linking product.

Binder: ingredient used to bind together two or more other materials in mixtures. A binder is an important organic constituent of a finish and is typically a polymer.

Viscosity reducers for cross linking agents have to be selected with care considering several factors. First of all, they have to be selected from the group of low viscous materials. Further, they have to be inert, considering the functional groups of the cross linker, to allow for a long shelf life. E.g., aminofunctions and primary hydroxyl functions are excluded when the cross linking agent is of isocyanate type. The volatility of the viscosity reducer must be insignificant and it must be environmentally benign. Good miscibility with the cross linking agent, and in aqueous systems, good compatibility with water, is a request. Good compatibility with the polymer of the binder of the finish is essential since otherwise the viscosity reducing agent will leave the coating film resulting in a greasy surface or in other kind of coating defects. Further, the viscosity reducer must not pertubate the process where curing product and the binder are homogenised, since this would result in the formation of threads, lumps etc.

Suitable viscosity reducing compounds typically have no primary or secondary hydroxyl, amino, thiol groups or other groups with a significant nucleophilicity but may have ketone, ester or ether functions. The volatility is low, the boiling point is typically >250° C. at atmospheric pressure. In one embodiment the boiling point is >260° C., in another embodiment it is >270° C. In a further embodiment the boiling point is >280° C., in still a further embodiment it is >290° C. In another embodiment the boiling point is >300° C., in still another it is >310° C. and in yet another it is >320° C. The compatibility of the viscosity reducing compound and the binder and the curing agent can to some extent be expressed by log P, where P is the partition coefficient. According to the present invention the log P should be <7.0, preferably <3.5, more preferably <3.1. In one embodiment the log P is <2.6 and in a further embodiment the log P is 2.1.

According to the present invention the log P is calculated using the ALOGPS 2.1 program, which can be found on the webpage of VCCLAB, Virtual Computational Chemistry Laboratory, http://www.vcclab.org, 2005.

Viscosity reducing compounds may be selected from the group of ketones, esters and ethers having a boiling point and a log P according to the above, or mixtures thereof. Suitable viscosity reducers are selected from the group consisting of polyol esters such as glycerol acetate and propanoate, erythritol acetate and propanoate, trimethylolpropane acetate and propionate, pentaerythritol acetate and propanoate, or esters of polycarboxylic acids such as citrates, such as triethyl citrate, triethyl acetylcitrate, and tributyl citrate, or diethyl diacetyltartrate, diethyl butanoylmalate and oligoethylene glycol derivatives, such as oligoethylene glycol alkyl ether esters such as diethylene glycol monobutyl ether butanoate and triethylene glycol monobutyl ether benzoate, or oligoethylene glycol dialkanoates such as triethylene glycol diacetate, triethylene glycol dibutanoate, tripropylene glycol diacrylate and dicarboxylates, and products under the trade name Citrofol, or silicon compounds such as silicates such as alkylalkoxysilanes such as alkyltriethoxysilanes, or ethyl oligosilicates such as Dynasylan 40, ex Degussa, or a phosphate such as trimethyl phosphate, triethyl phosphate, tributyl phosphate and ethyl ethylene phosphate, or an ether such as a dioxolane, a dioxane or a bicyclooctane such as a 2,6,7-trioxabicyclo[2.2.2]octane, or a ketone such as 3,3,5,5-tetramethylcyclohexanone.

The cross linking agent of the cross linking product is typically a polyisocyanate, a polyaziridine, a polysilane or mixtures thereof. The cross linking agent is made water compatible by reaction with a hydrophilic agent or by the addition of a compatibilising agent such as a surface active agent as described in US2010168297 and commercially available from Perstorp under the tradename Easaqua. Cross linking agents made hydrophilic by chemical reaction are for example products of isocyanate compounds and compounds having an ionic group or a group convertible into an ionic group or having non ionic hydrophilic groups. Suitable covalently modified cross linking agents are described in U.S. Pat. No. 5,587,421 with the addendum of cross linking agents made from e.g. isocyanates by reaction with hydroxy-2-thiocarboxylic acids and oxidized products thereof as described in EP1973874. Commercial hydrophilic cross linking agents are available from e.g., Bayer under the trade name Bayhydur, from Evonik under the name Vestanate, or from BASF under the name Basonat.

The coating binder to be cross linked by the cross linking agent of the cross linking product of the present invention is typically an aqueous acrylic dispersion, an aqueous polyurethane dispersion, a hybrid or a mixture thereof, or an alkyd or oil emulsion or solution. The binder may, or may not, carry functional groups reactive towards the reactive groups of the cross linker. Such groups are found in the category of hydroxyl, amino, hydrazido, mercapto, hydroxysilyl, and carboxyl functionalities. For the event, the binder molecule has no obvious functionalities reactive towards the reactive functionalities of the cross linking agent, the property improvement of the coating, on cure, may be caused by the formation of an interpenetrating network by the polymer molecules of the binder and a polymer formed by the cross linking agent by reaction with e.g. water, polyols, polyamines, or polyhydrazides. The binder may, or may not, carry further reactive functional groups such as acrylate or methacrylate groups.

Finishes containing suitable binders are available from e.g. Bona AB under the brands Bona Traffic, Bona Traffic Antislip, Bona Mega, Bona Novia, Bona Prime Amberseal, Bona Prime Classic, Bona Prime Intense, Bona Prime Tempo, Bona Prime Trowel, Bona Naturale, Bona Sportive, from Alcro under the name Parkett, from FlUgger under the name Fluganyl Golvakrylat or Golvlack, or from Beckers under the names Golv Klarlack V, Parkettlack Blank, Golv och Parkettlack Matt, from Herdins under the name Herdins Golvlack, or from Landora under the name Landora Golvlack V, or from Pallman under the name Pall-X-94, Pall-X-96, Pall-X-98, or Pall-X Nano, or from Loba under the name Lobadur

Typically, the cross linking product is composed of a mixture of at least one cross linking agent and at least one viscosity reducer in a ratio of 1/10 to 100/1, such as 1/5 to 20/1, for example 2/1 to 10/1, such as 1/1 to 5/1.

Typically, the cross linking product is added to the at least one finish in a ratio of 1/100 to 1/1, for example 1/50 to 1/2, such as 1/25 to 1/3, for example 1/10 to 1/5. The addition of the cross linking product to the at least one finish is typically done with shaking, stirring etc.

### EXAMPLES

For illustrative purpose, properties of some viscosity reducers are given in Table 1.

TABLE 1

| | Boiling point at | Calculated | Viscosity/ |
|---|---|---|---|
| Viscosity reducer | 760 Torr/° C. | log P | mPas |
| Triacetin | 258 | 0.32 | 17 |
| Citrofol A1 | 316 | 0.63 | 35 |
| Citrofol A2 | 323 | 1.15 | 54 |

The cross linking product according to the present invention is prepared by mixing, preferably with stirring, the cross linking agent (CLA) and the viscosity reducer. In table 2 different examples of crosslinking products are given.

TABLE 2

| | | | Conc. | Viscosity of |
|---|---|---|---|---|
| | Cross linking | Viscosity | viscosity | cross linking |
| Ex. | agent | reducer | reducer/% | product/mPas |
| 1 | Vestanat EP-HP | triacetin | 35 | 490 |
| | 1914 | | | |
| 2 | Easaqua XM 502 | Citrofol A1 | 35 | 4500 |
| 3 | Basonat HW 100 | Citrofol A1 | 35 | 910 |
| 4 | Basonat LR 9056 | Citrofol A1 | 35 | |
| 5 | Vestanat EP-HP | Citrofol A1 | 35 | 600 |
| | 1914 | | | |
| 6 | Bayhydur 305 | Citrofol A1 | 35 | |
| 7 | Vestanat EP-HP | Citrofol A1 | 35 | 570 |
| | 2044 | | | |
| 8 | Easaqua XM 502 | Citrofol A2 | 35 | 770 |

A ready to use product according to the present invention may be prepared by mixing, preferably by shaking, a finish and the cross linking product.

Cross linking products according to the present invention were mixed with a finish. The product was applied to a Leneta card and left to dry and cure.

TABLE 3

| | | | Amount cross | |
|---|---|---|---|---|
| | | Cross linking | linking product/ | |
| Ex. | Finish | product | (g/100 g finish) | Gloss at 60° |
| 9 | 476-60A | From ex. 1 | 5 | 86 |
| 10 | 498-01A | From ex. 1 | 10 | 86 |
| 11 | 476-60A | From ex. 2 | 5 | 85 |
| 12 | 476-60A | From ex. 3 | 5 | 85 |
| 13 | 476-60A | From ex. 4 | 5 | 83 |
| 14 | 476-60A | From ex. 5 | 5 | 87 |
| 15 | 476-60A | From ex. 6 | 5 | 87 |
| 16 | 476-60A | From ex. 7 | 5 | 87 |
| 17 | 498-01A | From ex. 5 | 10 | 87 |
| 18 | 498-01A | From ex. 6 | 10 | 85 |
| 19 | 476-60A | From ex. 8 | 5 | 86 |
| 20 | 498-01A | From ex. 8 | 10 | 86 |

A cross linking product according to the present invention was prepared by mixing the cross linking agent Easaqua XM and a viscosity reducer in a ratio of 4 to 1. The crosslinking product was used in examples 21-40. Yet another crosslinking product was prepared by mixing the cross linking agent Vestanat EP-HP 1914 with butylene carbonate in a ratio of 1.86 to 1. This crosslinking product was used in example 42.

TABLE 4

| | | | Amount | |
|---|---|---|---|---|
| | | | cross- | |
| | | | linking | |
| | | | product | |
| | | Cross linking product based | (g/100 | Gloss |
| Ex. | Finish | on the viscosity reducer: | finish) | at 60 |
| 21 | Traffic HD blank | Benzoflex 2088 | 10 | 86 |
| 22 | Traffic HD blank | Benzoflex 50 | 10 | 86 |
| 23 | Traffic HD blank | 3G8 [triethylene glycol di(2- | 10 | 85 |
| | | ethylhexanoate)] | | |
| 24 | Traffic HD blank | Tripropionin, glycerol | 10 | 85 |
| | | tripropanoate | | |
| 25 | Traffic HD blank | Plastomoll DOA, bis(2- | 10 | 83 |
| | | ethylhexyl) adipate | | |
| 26 | Traffic HD blank | Citrofol B1, tributyl citrate | 10 | 83 |
| 27 | Traffic HD blank | TXIB, 2,2,4-trimethyl-1,3- | 10 | 83 |
| | | pentanediol diisobutyrate | | |
| 28 | Traffic HD blank | Velate 368, 2-ethylhexyl | 10 | 84 |
| | | benzoate | | |
| 29 | Traffic HD blank | Methyl ester CE 1875A, a fatty | 10 | 84 |
| | | acid methyl ester mixture | | |
| 30 | Traffic HD blank | Tributyrin, glycerol tributanoate | 10 | 85 |
| 31 | Traffic HD blank | Hexamoll DINCH, diisononyl | 10 | 82 |
| | | cyclohexanedicarboxylate | | |
| 32 | Traffic HD blank | Plastomoll DNA, diisononyl | 10 | 84 |
| | | adipate | | |
| 33 | Traffic HD blank | TBEP, tributyl phosphate | 10 | 85 |
| 34 | Traffic HD blank | Loxanol EFC 300, fatty acid | 10 | 83 |
| | | derivative | | |
| 35 | Traffic HD blank | Linseed methyl esters | 10 | 85 |
| 36 | Traffic HD blank | Methyl linoleate | 10 | 85 |
| 37 | Traffic HD blank | SR 454, ethoxyloated (3) TPM | 10 | 86 |
| | | triacrylate | | |
| 38 | Traffic HD blank | Deolink Epoxy DE-100, 3-(2,3- | 10 | 85 |
| | | Epoxypropoxy)propyl] | | |
| | | methyldiethoxysilan | | |
| 39 | Traffic HD blank | Coatosil MP 200, an epoxy | 10 | 85 |
| | | functional silane oligomer | | |
| 40 | Traffic HD blank | Silquest Y-9936, 3- | 10 | 86 |
| | | (triethoxysilyl)propyl | | |
| | | methacrylate | | |
| 41 | Traffic HD blank | Butylene carbonate | 10 | 85 |

The high gloss of dry and cured surfaces, as seen above, indicates that the cross linking product is well dispersed and has good compatibility with the finish. Other important properties such as black heal mark, chemical resistance, scratch resistance of the surfaces were also assessed and found excellent. The pot life of the finish after admixing the cross linking product and of the cross linking product itself is at least 4 h.

1. A VOC free cross linking product for waterborn coatings, comprising at least one cross linking agent and at least one viscosity reducing compound.

2. A VOC free cross linking product according to claim 1, wherein said at least one cross linking agent and said at least one viscosity reducing compound are present in a ratio of 1/10 to 100/1.

3. A VOC free cross linking product according to claim 2, wherein said at least one cross linking agent and said at least one viscosity reducing compound are present in a ratio of 1/5 to 20/1.

4. A VOC free cross linking product according to claim 3, wherein said at least one cross linking agent and said at least one viscosity reducing compound are present in a ratio of 1/2 to 10/1.

5. A VOC free cross linking product according to claim 4, wherein said at least one cross linking agent and said at least one viscosity reducing compound are present in a ratio of 1/1 to 5/1.

6. A VOC free cross linking product according to claim 1, wherein the boiling point of said at least one viscosity reducing compound is >250° C. at atmospheric pressure.

7. A VOC free cross linking product according to claim 1, wherein said at least one viscosity reducing compound has a calculated log P of <7.0.

8. A VOC free cross linking product according to claim 1, wherein said at least one viscosity reducing compound is chosen from ketones, esters, ethers or mixtures thereof.

9. A VOC free cross linking product according to claim 1, wherein said at least one viscosity reducing compound is chosen from lactates, citrates, tartrates, malates, phosphates, silicates, glycol esters, glycerol esters, dicarboxylates or mixtures thereof.

10. A VOC free cross linking product according to claim 9, wherein said at least one viscosity reducing compound is a citrate.

11. A VOC free cross linking product according to claim 9, wherein said at least one viscosity reducing compound is a glycerol ester.

12. A VOC free cross linking product according to claim 9, wherein the citrate is chosen from triethyl citrate, tributyl citrate, triethyl acetylcitrate or a mixture thereof.

13. A VOC free cross linking product according to claim 9, wherein the glycerol ester is chosen from triacetin, tripropionin, tributyrin or a mixture thereof.

14. A coating formulation comprising a VOC free cross linking product according to claim 1.

15. A coating formulation according to claim 14, further comprising at least one finish.

16. A coating formulation according to claim 15, wherein the cross linking product and said at least one finish are present in a ratio of 1/100 to 1/1.

17. A coating formulation according to claim 16, wherein the cross linking product and said at least one finish are present in a ratio of 1/50 to 1/2.

18. A coating formulation according to claim 17, wherein the cross linking product and said at least one finish are present in a ratio of 1/25 to 1/3.

19. A coating formulation according to claim 18, wherein the cross linking product and said at least one finish are present in a ratio of 1/10 to 1/5.

20. A surface coated by a coating formulation according to claim 14.

21. A method for producing a VOC free crosslinking product according to claim 1, wherein a cross linking agent is mixed with a viscosity reducing agent.
